(19) United States
(12) Patent Application Publication
(10) Pub. No.: US 2014/0015439 A1
(43) Pub. Date: Jan. 16, 2014

(54) TROFFER LIGHTING CONTROL SYSTEM

(71) Applicants: Martin R. Cobb, Northbrook, IL (US); Timothy R. Kozeny, Northbrook, IL (US); Aleksey Pashkin, Arlington Heights, IL (US)

(72) Inventors: Martin R. Cobb, Northbrook, IL (US); Timothy R. Kozeny, Northbrook, IL (US); Aleksey Pashkin, Arlington Heights, IL (US)

(73) Assignee: INDAK MANUFACTURING CORP., Northbrook, IL (US)

(21) Appl. No.: 13/549,735

(22) Filed: Jul. 16, 2012

(51) Int. Cl. H05B 37/02

(52) U.S. Cl. 315/294

(57) ABSTRACT

A lighting control system for a troffer LED lighting system is provided with a power supply having at least three pairs of wires extending therefrom. The first pair of wires is in connection with a power source. The second pair of wires is connected to a socket mounted to the troffer housing. The third pair of wires is connected to at least one LED. A socket resistor is mounted to socket to set a baseline brightness for the troffer LED lighting system, and an efficiency plug is provided for insertion into the socket. The efficiency plug includes an internal resistance to change the brightness of the troffer LED lighting system to a predetermined level.

### FIELD OF THE INVENTION

The present invention relates generally to a system to control the brightness of a troffer lighting assembly.

### BACKGROUND OF THE INVENTION

Conventional overhead recessed lighting fixtures known as troffers are designed to conform to ceilings such that the lower edge of the fixture is nearly flush with the underside of the ceiling tiles. These lighting fixtures may be equipped with light emitting diodes (generally referred to herein as “LEDs”).

Lighting systems may be either too bright or not bright enough for conditions and occupant preference. With LEDs the brightness and efficiency are closely but inversely related. As such, when the brightness is increased the efficiency decreases.

### SUMMARY OF THE INVENTION

To overcome this problem, one or more embodiments of the present invention provides for a system to control the brightness and/or efficiency of a troffer lighting system. The system includes a power supply having at least three pairs of wires extending therefrom. The first pair of wires is in connection with a power source, while the second pair of wires is in connection to a socket mounted through the housing. The third pair of wires is in connection with the LED circuit board. A socket resistor is mounted to the socket to set a baseline brightness for the troffer LED lighting system. An efficiency plug may be inserted into the socket. The efficiency plug includes an internal resistance to change the brightness for the troffer LED lighting system to a predetermined level. Multiple efficiency plugs can be provided with different internal resistance. The efficiency plugs would be interchangeable depending upon the user's preference. For example, one efficiency plug could change the brightness for the troffer LED lighting system to a level greater than the baseline brightness; while another efficiency plug changes the brightness for the troffer LED lighting system to a level less than the baseline.

In addition, the system may include a dimmer system having a potentiometer plug. The potentiometer plug is configured for insertion into the socket such that a user can adjust the brightness level of the LEDs. In other aspects of the invention, multiple plugs can be wired to a single potentiometer such that a user can adjust multiple troffers at the same time.

Numerous other advantages and features of the invention will become readily apparent from the following detailed description of the invention and the embodiments thereof, from the claims, and from the accompanying drawings.

### BRIEF DESCRIPTION OF THE DRAWINGS

A fuller understanding of the foregoing may be had by reference to the accompanying drawings, wherein:

FIG. 1 is a close-up perspective view of a troffer lighting system with a lighting control system in accordance with one or more embodiments of the present invention;

FIG. 2 is an enlarged perspective view of FIG. 1;

FIG. 3A is an outside view of the housing illustrating a socket;

FIG. 3B is an enlarged perspective view showing the socket from FIG. 3A;

FIG. 4A is a perspective view of an efficiency plug to re-set the resistance of the control system;

FIG. 4B is a perspective view of the socket from FIG. 3B illustrating the inserted efficiency plug;

FIG. 5A and 5B are perspective views of a dimming control with a potentiometer plug;

FIG. 6A is a schematic illustrating the system without an efficiency plug; and

FIG. 6B is a schematic illustrating the system with an efficiency plug.

### DETAILED DESCRIPTION OF THE EMBODIMENTS

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or claims of the embodiments illustrated.

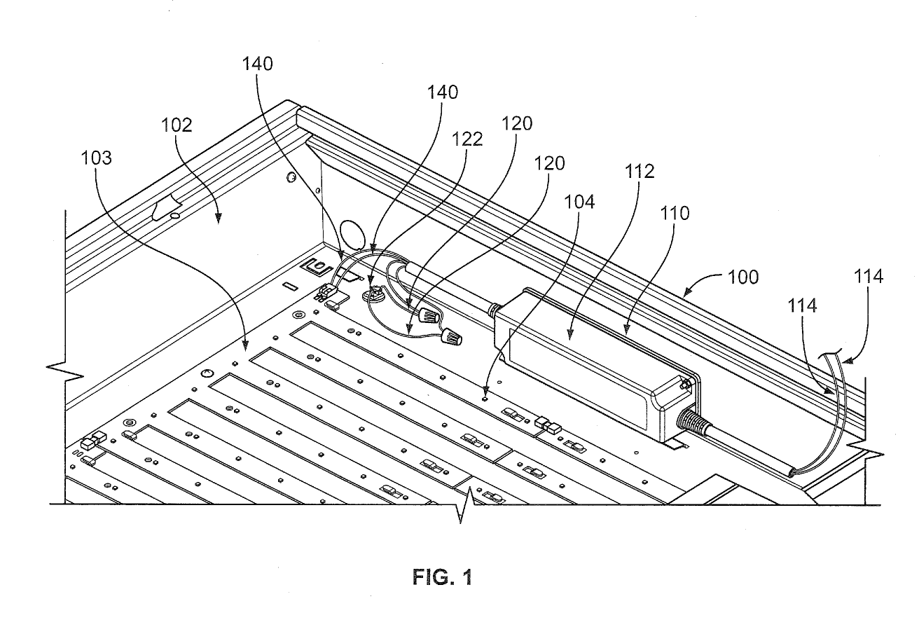

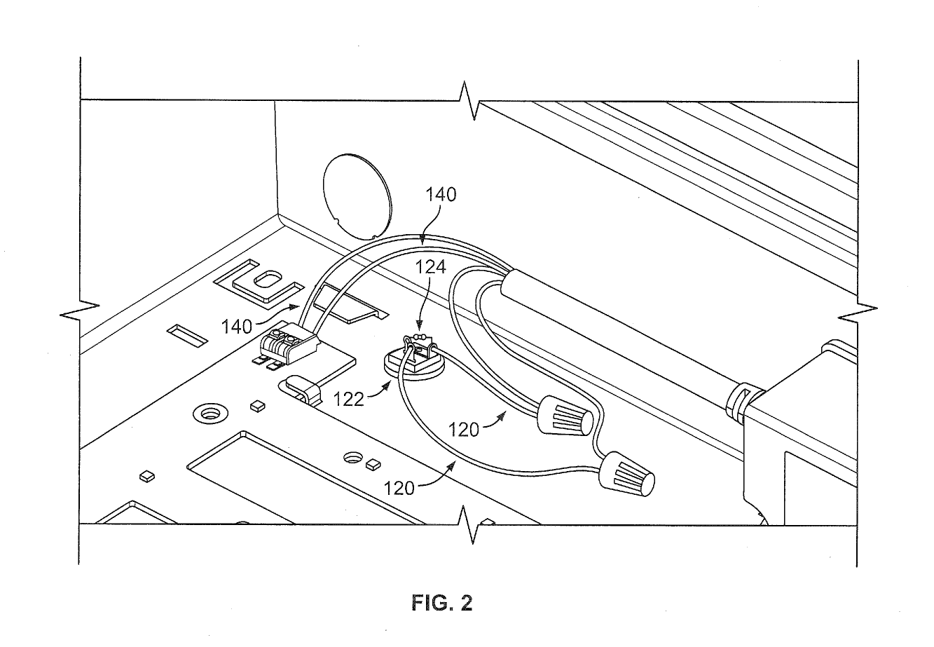

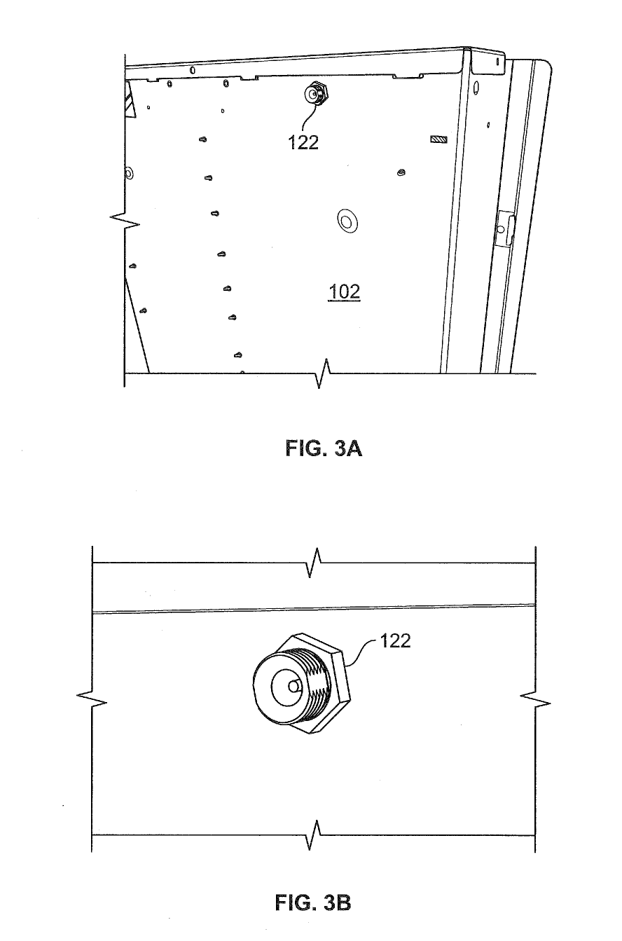

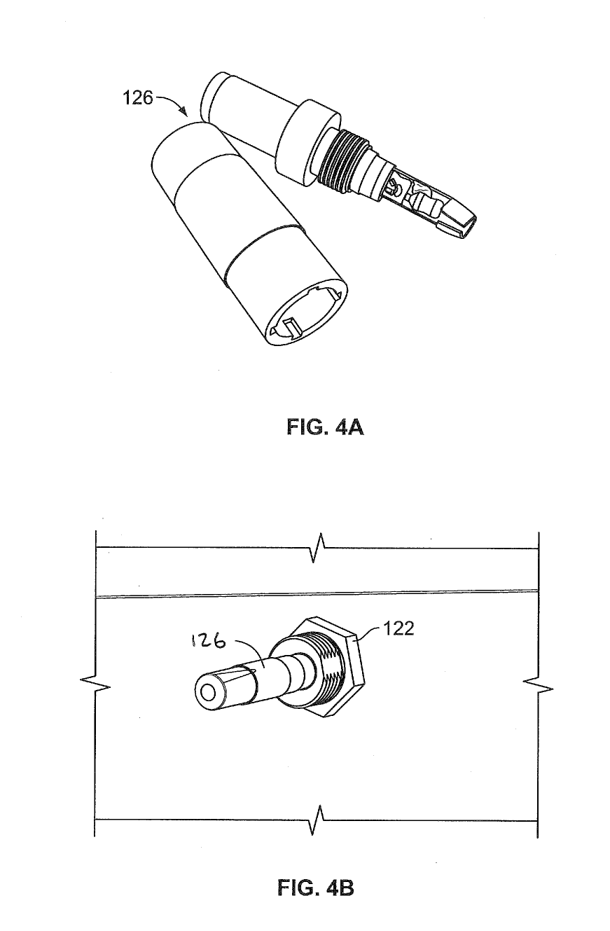

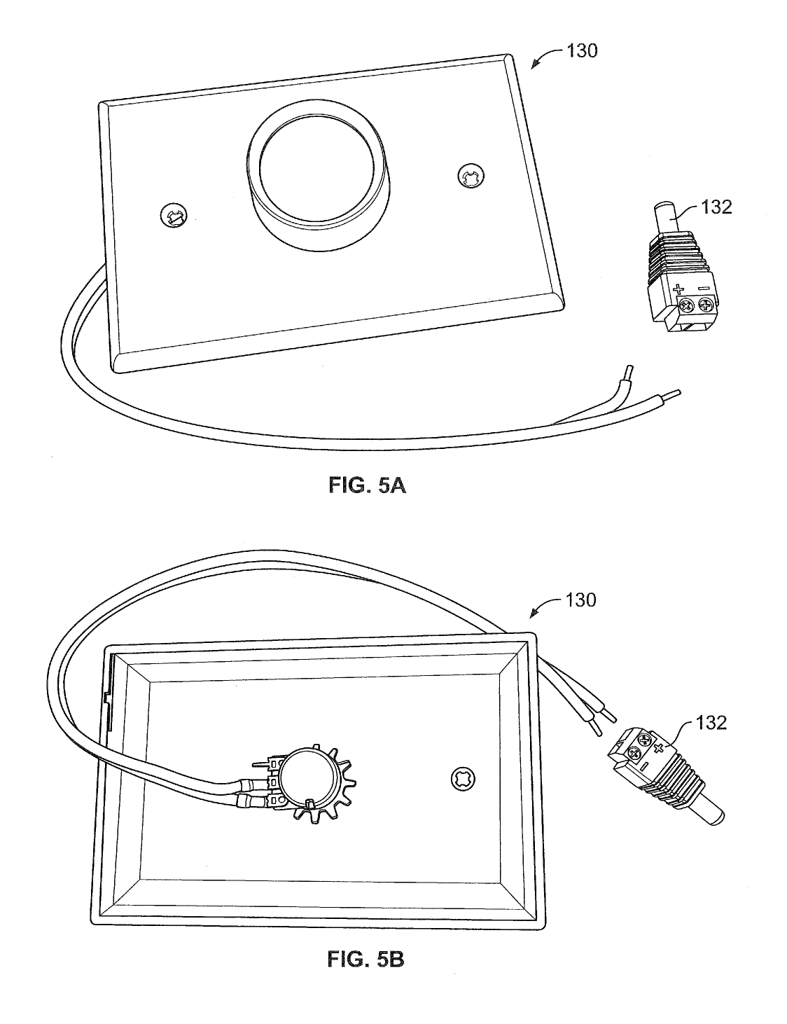

Referring now to FIGS. 1-6B, there is shown a troffer lighting system 100 which includes a lighting control system 110 in accordance with one or more embodiments of the present invention. The troffer lighting system 100 includes a housing 102 that is affixed to a ceiling (not shown). The housing 102 provides for a means to secure a plurality of light emitting diodes (LEDs) 104 which are connected to the lighting control system 110.

The lighting control system 110 includes a power supply 112 which has three pairs of wires extending therefrom. The first pair 114 will connect to an AC power source with perhaps 110, 220, or 277 volts (not shown).

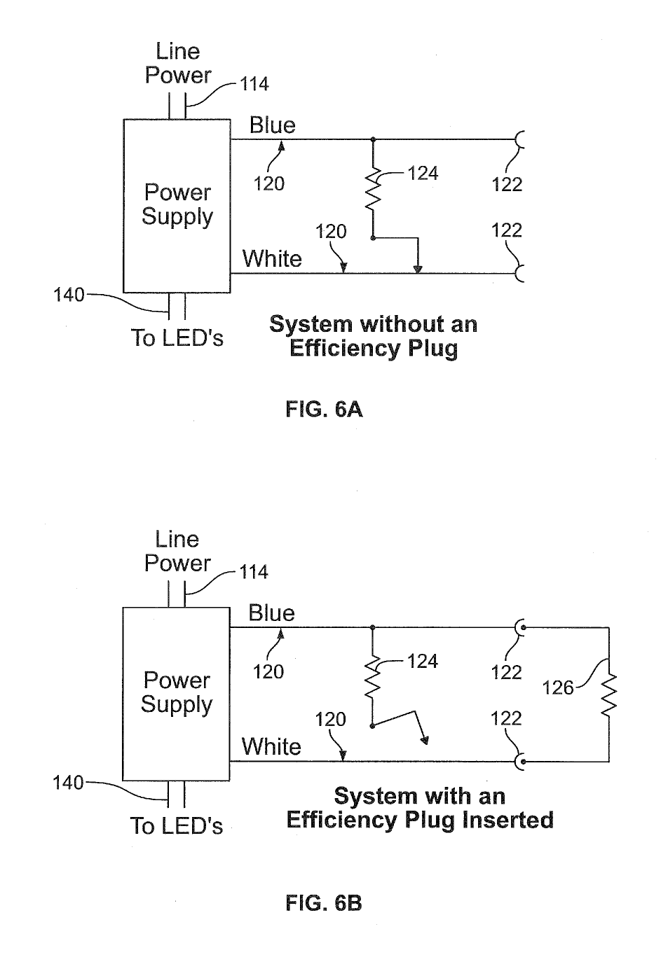

The second pair of wires 120 connect to a socket 122 mounted through the housing 102. The socket 122 further includes a resistor 124 mounted thereon (on the inside portion of the housing 102) to set the baseline brightness of the troffer. The resistor 124 typically sets the baseline brightness of the troffer to about 60% of its potential. From the outside of the housing 102 the socket 122 allows for an efficiency plug 126 to be inserted thereto. The efficiency plug 126 changes the resistance between the second pair of wires 120, such that the brightness can be increased. In other instances, the efficiency plug 126 changes the brightness to below the baseline brightness. A simple schematic in FIGS. 6A and 6B are provided to show the connection with the efficiency plugs.

A dimmer system 130 with a potentiometer plug 132 could also be used and inserted into one of the sockets 126 such that the user can control the brightness level. In addition, this permits multiple cable plugs to be wired to a single potentiometer such that the user can control multiple troffers at once.

The third pair of wires 140 connect to a printed circuit board 103 in communication with the LEDs. The third pair of wires 140 will feed the power to the LEDs at a specific brightness controlled by either the socket 122, or the efficiency plug 126 or the potentiometer plug 132 when inserted into the socket 122.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred.

We claim:

1. A brightness control system for a troffer LED lighting system, the troffer LED lighting system having a housing containing a printed circuit board on which at least one LED is mounted, the brightness control system comprising:
a power supply having at least three pairs of wires extending therefrom, wherein a first pair of wires is configured to be connected to a power source, a second pair of wires in connection with a socket mounted through the housing, and the third pair of wires is in connection with the printed circuit board, the power supply being configured to supply power from a power source to the printed circuit board for illuminating the at least one LED;
a socket resistor mounted to the socket to set a baseline brightness for the troffer LED lighting system; and
an efficiency plug inserted into the socket, the efficiency plug includes an internal resistance to change the brightness of the troffer LED lighting system to a predetermined level.

2. The system of claim 1, wherein the socket resistor sets the baseline brightness for the troffer LED lighting system to about 60% of the LEDs potential.

3. The system of claim 2, wherein the efficiency plug changes the brightness for the troffer LED lighting system to a level greater than the baseline brightness.

4. The system of claim 2, wherein the efficiency plug changes the baseline brightness for the troffer LED lighting system to a level less than the baseline brightness.

5. The system of claim 2 further comprising a dimmer system having a potentiometer plug, wherein the potentiometer plug is configured for insertion into the socket such that a user can adjust the brightness level of the LEDs.

6. The system of claim 5, wherein multiple cable plugs can be wired to a single potentiometer such that a user can adjust multiple troffers at the same time.

7. A lighting control system for a troffer LED lighting system, the troffer LED lighting system having a housing with at least one LED, the lighting control system comprising:
a socket mounted to the housing, the socket having a socket resistor to set a baseline brightness for the troffer LED lighting system;
a power supply having at least three pairs of wires extending therefrom, wherein a first pair of wires is configured to be in communication with a power source, a second pair of wires is configured to be in communication with the socket, and the third pair of wires is configured to be in electrical communication with the LED;
an efficiency plug for insertion into the socket, the efficiency plug includes an internal resistance which when the efficiency plug is inserted into the socket changes the brightness of the troffer LED lighting system to a predetermined level set by the internal resistance, and wherein the output plug is configured to change the baseline brightness for the troffer LED lighting system to either a level greater than or to a level less than the baseline brightness.

8. The system of claim 7 further comprising a dimmer system having a potentiometer plug, wherein the potentiometer plug is configured for insertion into the socket such that a user can adjust the brightness level of the LEDs.

9. The system of claim 8, wherein multiple cable plugs can be wired to a single potentiometer such that a user can adjust multiple troffers at the same time.

10. A lighting control system for a troffer LED lighting system, the troffer LED lighting system having a housing with at least one LED, the lighting control system comprising:
a socket mounted to the housing, the socket having a socket resistor to set a baseline brightness for the troffer LED lighting system;
a power supply having at least three pairs of wires extending therefrom, wherein a first pair of wires is configured to be in communication with a power source, a second pair of wires is configured to be in communication with the socket, and the third pair of wires is configured to be in electrical communication with the at least one LED, such that when connected the at least one LED will illuminate at the baseline brightness;
an efficiency plug for insertion into the socket, the efficiency plug includes an internal resistance which, when inserted into the socket, changes the brightness of the troffer LED lighting system to a predetermined level set by the internal resistance.

11. The system of claim 10, wherein the output plug is configured to change the baseline brightness for the troffer LED lighting system to a level greater than the baseline brightness.

11. The system of claim 10, wherein the output plug is configured to change the baseline brightness for the troffer LED lighting system to a level less than the baseline brightness.

12. The system of claim 10 further comprising a dimmer system having a potentiometer plug, wherein the potentiometer plug is configured for insertion into the socket, and which when inserted permits a user to adjust the brightness level of the LEDs.

13. The system of claim 9, wherein multiple cable plugs can be wired to a single potentiometer such that a user can adjust multiple troffers at the same time.
